(19) United States
(12) Patent Application Publication
(10) Pub. No.: US 2016/0239254 A1
(43) Pub. Date: Aug. 18, 2016

(54) Methods and Apparatuses for Creation and Modification of Digital Sounds

(71) Applicant: Anthony Mai, San Marcos, CA (US)

(72) Inventor: Anthony Mai, San Marcos, CA (US)

(21) Appl. No.: 14/622,885

(22) Filed: Feb. 15, 2015

(51) Int. Cl. G06F 3/16

(52) U.S. Cl. CPC G06F 3/165

(57) ABSTRACT

Methods and apparatuses for efficient generation and processing of high quality digital sounds that appear to be natural and realistic to human listener. By reviewing the shortcomings of prior arts and considering the physics involved in how sounds are generated in the physical world, current invention provides algorithmic structures and procedures to generate and process digital sounds that are realistic and rich in harmonies and entropy, and provides a feeling of warmth to human listeners. The current invention has broad application in music, movies, games and other multimedia content creation and processing; in voice communication applications and products; and in developing better human computer interaction technologies.

### FIELD OF INVENTION

The current invention relates to the field of digital signal processing for audio and entertainment contents. Specifically, the current invention can be used in creating and processing digital audio contents and in developing software and hardware products in digital audio content creation and processing. The current invention has wide application and huge values in anything that is related to entertainment content creations, including movies, music and computer games.

### BACKGROUND OF INVENTION

The invention and widespread application of digital computers is one of the biggest progresses in human civilization. Devices with high computing power allow audio and video contents to be recorded, processed and delivered for entertainment and other purposes through computation, using various digital processing technology invented. Computer technologies in multimedia content processing have become so powerful that almost every visual scenes of a complete movie can be created from mind concept to final finished product purely through the co-operative works of artists and engineers as well as computer processing, without using any photo or video recorded from the reality world. Everything you see are created by a computer.

But the same cannot be said about the audio portion of multimedia contents. Even though various sophisticated algorithms have been invented to process digital sound to create various kinds of audio effects, practically every digital sound in current day multimedia contents can chase its origin to an initial recording of actual sound. If a character in a movie or animation speaks, the speech was recorded using a microphone from somebody's actual speech. If there is sound of rain, wind or bird chiming in a movie, the sounds originally came from audio samples carefully recorded from the natural environment. Even modern computer text to speech products must rely on recording human speech samples and then tailor bits and pieces together seamlessly to form continuous artificial computer speech sound. Computing algorithms that can efficiently produce high quality realistic digital sounds are long sought after but were never achieved.

The reason why visual contents are created easily by a computer, but audio contents are so hard to create lies in the difference between the two. Visual scenes are mostly static with geometry shapes and contours well understood by mathematics and physics. So they are very to be created by computation. Visual scenes without a high number of moving objects requires a tremendous amount of computing power to create, but through various methods of simplification and optimization, such required computing power is still available by existing technology today, especially when the computing does not have to be done in real time, like in movie production.

On another hand, even though sound is just mechanical wave, and the basic physics of sound creation is well understood, trying to simulate natural sound creation still requires such high computing power that they are simply not feasible by today's technology. In some simpler cases, like sound created by a music instruments or items of simple and well modeled geometry, computer simulation of the sound creation process is achievable. But in most cases, it is not. In even the most trivial sound creation physical events, like a rock hits the ground and rolling, the actual physics involves many small pieces of materials as small as an atom, interacting with each other in infinitely possible ways, and many waves bounce off many irregular boundaries and be absorbed and created. The physics process is just too complicated to be calculated by a computer.

Through mathematics development, Discrete Signal Processing (DSP) technology was developed to process sampled digital sounds. They can modify characters of digital sounds and can create simple audio effects. But they cannot create sounds from just physical models.

### SUMMARY OF INVENTION

The present invention provides novel methods and apparatuses to create high quality and realistic digital sound by computational means. Working principles of present invention are radically different from traditional DSP technology. The DSP is based on mathematical theory. The principles of current invention are based on real physics principles like energy conservation.

Let me review how current DSP technologies fail to re-produce the real physics. DSP records sounds as waveforms sampled at precise and uniform time intervals. For example, 44.1 KHz and 16 bits audio is created by measuring the sound wave 44100 times per second. Each measurement gives a value with 16 bits accuracy, or an integer value between −2̂15 and 2̂15−1, or between −32768 to +32767. Mathematics can prove that by such sampling, the sample data can represent any sound with frequency less than half of the sampling rate, called Nyquist Frequency, which is 22.05 KHz in this case. The sample values are sequentially placed into a computer memory buffer and moved one place at a time, going through a series of prescribed calculations based on their relative positions. At each step, for example, a value is fetched 2 places ahead or 3 places behind current value, scaled by a constant, then added to or subtracted from current value, then be put back into memory. After each step, the calculation moves to the next value and repeats. The sample calculation is repeated 44,100 times per second. The results are continuously sent to an audio device for Digital-to-Analog conversion into physical sound.

Due to inherent periodicity of the above described DSP calculation steps, different frequency components of sounds can be enhanced or suppressed, and other useful audio effects can be produced. It can also generate very simple sound waves like sine wave or triangle waves. However, such mathematical process is overly simplified. It contains too much regularity and coincidence with rigorous mathematical precision, thus the sounds generated is unnatural, and often sounds robotic or metallic. This is because mathematics based DSP violates the physics.

For example, current value can be scaled and added to a value 200 places behind itself, skipping other values in between, as computers can store historic samples for calculation. This is equivalent to “action at distance” in physics, which is impossible and non-physical. The physical world cannot memorize sounds. Moreover, when sample values are scaled and added, energy is gained out of nothing, which could lead to uncontrolled signal saturation. But energy is conserved in the physical world. Sound energy decreases and dissipates into heat energy. Unless energy is feed continuously to sustain the sounds, they fade off pretty quickly.

A more effective method of modeling natural sounds must respect the physics rules. Physical sound creation involves many small and quickly varying mechanical movements of many small pieces of material in completely random and chaotic fashion. The pieces presses each other and changes each other's movement a gazillion times per second. There is no way a computer can simulating the bouncing and collision of gazillions of air particles. Fortunately we do not need to. Note sound waves are never memorized by the environment. Sounds just bounce around various boundaries and keep intermixing randomly. Out of the chaos, random movements begin to gain a rhythm with each other and rhymes with certain movements while cancels others. This is the sound we hear in nature, with the characters associated with material properties and geometry shapes. Our ears cannot heard the randomness, our ears heard the co-operative rhymes. It is possible to simulate the collective order part and get the needed randomness from a random number generator. We do not need a super computer just to calculate randomness. It is sufficient to use a small number of parts to simulate the collective movements that emerges over time.

The current invention provides methods to use a limited number of action units to simulate random and memory-less movements that resonate over time, to generate sounds of desired characters. Such action units are connected together to form a number of grid structures, with some units directly interact with their neighbors, while others do not. As units only interact with their neighbors and are forgetful, they help avoid “action at distance” which is prohibited in physics. A variety of actions and interactions are defined to specify how the units evolve and impact each other over time, with physics laws obeyed. Each unit is updated at specific time steps based on the actions and interactions. The time steps do not have to be fixed or uniform. It can vary between units and can change for each unit. Through all these, physics laws are obeyed, and plenty of randomness is introduced. The results are simulated sounds that are realistic to ears.

Like described above, the methods provided by the current invention contain four types of elements: Action units, interactions, structures and iterations. all four elements can find their equivalences in the physical world, and obey the same physics laws. For an analogy, the current DSP technology also have the analogy of these four elements, but they break physics laws. In DSP, the units are just individual sample values of the sound signal. As each value is just a number, it has no physical property. Interaction is to merely scale some sample values to add them to other sample values a few positions away, skipping all other values in between. That correspond to non-physical “action in distance”. As for structures, the sample values are lined sequentially in a buffer, like a one dimensional structure. The physical world has 3-dimensions in space. As for iteration, one round of calculation is done precisely for each sample, separated by an artificial time interval, depending on the sampling rate. All these break physics laws. The physical world is never precise, exactly and regular, and allows only neighboring interactions.

The physical world is energy conserved. In the physical world, energy never comes out of nothing and then disappear into nothing. When sound wave is created, some other forms of energy, like mechanical energy, is turned into sound energy. Then the energy dissipates as the sound dies off, turning into heat energy, or random air molecule movements. Another physics principle is entropy can only increase. In sound waves, the movements of the many small parts become increasing random and un-predictable. Random movements dissipates into heat energy, as the sound dies off. However, some sound energy is preserved longer and enhanced because of emergency of the co-operative movements and order that emerges from chaos. That is the sound wave that we can hear. Realistic sound simulation must obey these rules.

Provided by current invention, each of the four basic elements mentioned above: action unit, interaction, structure and iteration, are attached physics meanings and observe physics laws. An action unit contains a set of variables and an action term to represent its physics property. For example, a unit can simulate a spring with a mass M attached, with spring constant K. It contains variables like position X, velocity V for time derivative of X, and acceleration A for time derivative of V. An action, or push H(T) can be defined based on these variables. When the action term is set to zero, the unit is analogy to a free oscillating spring at an angular velocity equal to the square root of K divided by M, thus the action term gives it a timing characteristics.

Notice when you push a spring, it does not push back immediately. It first yield to your push to retreat, then it pauses, then it comes back out to push you out. When many units of different time delay characters interact with each other, sound is thus created when coincidences raise spontaneously. The character that a unit does not immediately respond to an action, but has a delayed and transformed delay, leads to the timing property and entropy increasing property, two necessary ingredients to generate realistic natural sound waves.

For another example, a unit as provided by current invention can be designed to carry three variables: Q, I and I′, representing voltage, charge, current and derivative of current respectively, just like the same quantities in an electronic circuit. Physical property attributes like resistance, capacitance and inductance can be assigned to the unit to represent how these four variables are related to each other in how they evolve over time. An action or interaction term can be defined as a linear combination of Q, I and I′, and has the equivalence of voltage V.

For yet another example, abstract units can be defined using variables that do not assembly any real objects in the physical world, but represent variables and their first and second time derivatives respectively. Matrixes can be defined to calculate the actions and interacts of the units, and specifies how the units evolve time. The matrixes are defined in such a way that a term of energy can be defined, and shall remain mostly conserved under given transformation rules, and that entropy is likely to increase over time. Such systems constitute of such action units will be capable of synthesis natural sounds, whether or not they can find their equivalences in the physical world, like springs or electronic components.

In summary, the current invention provides apparatuses and methods for realistic and efficient simulation of natural sounds by a computing device. The current invention is radically different from all prior arts on a few points: It has no memory of history; It tries to sustain sound by sustaining energy instead of remembering the waves; It allows entropy to increase; The action units have states, comparing to discrete sample values. Current invention has four basic elements: 1. action units, 2. interactions, 3. connected structures, and 4. iteration processes. Such a system can simulate natural sounds realistically as they obey two physics laws: conservation of energy and increasing entropy. Actual embodiments can vary. But all practical embodiments of current invention will provide variables and their time derivatives, define memory-less actions and interactions, and define a quantity of energy which is mostly conserved over time, and will also provide ways for entropy to increase over time through each iteration process.

### BRIEF DESCRIPTION OF DRAWINGS

FIG. 1 shows a diagram of Embodiment Example One. The diagram contains one input unit, one action unit and one output unit. The input unit takes a timed event, which is a single impulse, and convert it to non-zero variables X, V, and A. The input unit then interacts with the action unit to energize it, causing the variables contained in the action unit to start to oscillate. Finally the output unit interacts with the action unit to follow its oscillation. The variables contained in the output unit is then converted to a single sampled output signal.

FIG. 2 shows a diagram of Embodiment Example Two. Like example one, the diagram contains one input unit, one action unit and one output unit. But the input signal is different. The input is a 44.1 KHz sample rate audio signal. The purpose of the system is to convert the audio to an output audio at a different sample rate 8 KHz. The input unit takes audio samples at 44.1 KHz and converts the value to values of three variables X, V, A, or displacement, velocity and acceleration. The input unit then interacts with the action unit to cause it to oscillate in sync with the input. Finally, the output unit interacts with the action unit to follow its variables and generate the output. The variables contained in the output unit is then converted to a single sampled output signal, by taking a linear mix of the three variables X, V, A in the output unit. Note that the three units are iterated at different time steps. The input unit is iterated 44100 times per second, the output unit operates at 8000 times per seconds. The action units iterates at each time when at least one of either input or output unit iterates.

FIG. 3 shows a diagram of a more complicated digital sound generation system based on current invention. It contains one input unit, one output unit, and 16 different action units. The input unit takes timed event inputs, which in this case are random impulses, and convert them into valued of three variables X, V, A of the input unit. The input unit then interacts with multiple action units to energize them. The action units interact with each other to pass energy around and oscillate in resonance. Finally an output unit interacts with a subset of action units to generate output in the set of X, V, A variables of the output unit. These values are linearly mixed to generated a single sampled output signal. The output may sounds like harmonic drum beats.

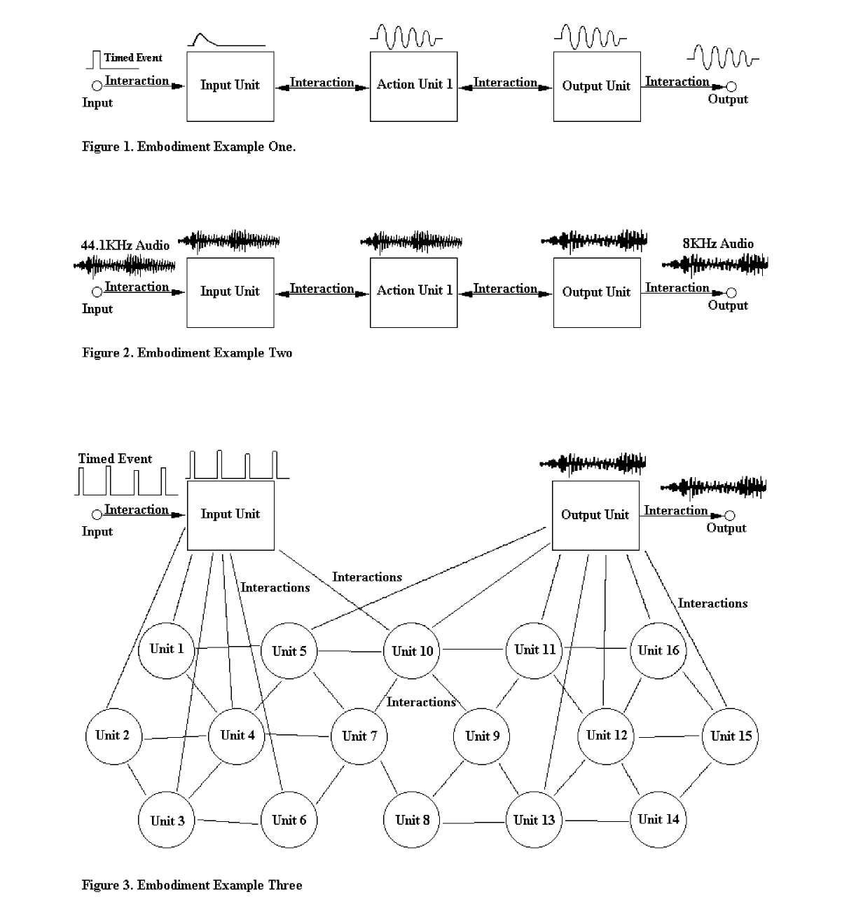

### DETAILED DESCRIPTION OF INVENTION

The current invention provides methods and apparatuses for efficient and realistic high quality creation of digital sound, through computation. It differs from the traditional DSP filter techniques fundamentally. In DSP, each element contains merely one numerical value, and all values are processed sequentially. For a variety of reasons, such DSP filtering techniques are too simplistic to reflect the complicated physical environments in which sounds are generated. So they are inadequate for generating high quality natural sounds.

As provided by current invention, natural sound simulation is accomplished using four different kinds of elements. Refer to claim 1, part 1B, 1C, 1D and 1F, these elements are:
1. Action units 2. Interactions 3. Connected structures 4. Iteration Processes
   The essential principles that differentiate current invention from all prior art are: The simulation system has states, but have no memory of its past. After each iteration step, the previous iteration is totally forgotten. The simulated sounds are sustained by propagation and energy conservation, not by remembering previous sample data. This is different from DSP based technology which must keep a series of historic sample values for filter computation and Fourier transformation.

Action units are the basic elements of computation, analogy to the individual sample values in DSP filter technologies. Each action unit contains one or many variables, and the first and second time derivatives of each such variable, and a plural of constants and formulas used to define action terms, i.e. how the variables relate to each other and evolve over time. In its simplest form, an action unit may contain a variable X for displacement, velocity V for the time derivative of X, and acceleration A for the time derivative of V. Refer to claim 1 part 1B.

An action unit also contains an action term H, defined as a linear combination of X, V and A. The action H is set to the tally of all interaction and reactions the unit receives. When the unit does not react with anything, the action H is set to zero. Fixing the value of H(T) at any time point allows the variables to be calculated and updated over time, first by calculating the second derivative A, and then calculate first derivative V and then the variable X. For example, H(T) for an isolated unit can be defined as H(T)=M*A+D*V+K*X=0. The constants used are analogy to the mass M, drag coefficient D and spring constant K in a spring-mass system.

Likewise, there can be interactions between units. Similarly an interaction I(T) can be defined as a linear combination of the variables of a unit: I(T)=m*A+d*V+k*X. Here the set of parameters used: m, d and k, defines an interaction. Interactions are mutual and opposites. They are given from one unit to the other, with an equal but opposite reaction given back to the unit that gives an interaction. Same set of parameters m, d and k is used to calculate interaction from unit A to unit B as from unit B and unit A. For each interaction given to the other unit, an opposite reaction is received from that unit. All interactions and reactions that a unit receives should be added to the action term H(T) of the unit, for calculating evolution of its variables.

Connected structures specify the topological structure of how action units are related to each other in their interactions. The units that interact with each other are connected. Each connection represents a mutual interaction between two units. The units that do not interact with each other directly are not directly connected. The action units are connected together to form a grid structure. The topological shape and form of the structure, analogy to physical shape of objects, affects the kind of sounds generated by the simulation. See claim 1 part 1D.

Finally, the actions and interactions are calculated in a process of iteration steps. Each iteration is to a small time step. The iteration steps may not be at precise and equal time intervals. They can be done in non-uniform time steps. Moreover, not all actions and interactions have to be iterated at each step. In general, faster responding actions and interactions are iterated more often, while slower or weaker ones are iterated less often. This reduces computation time, and introduces un-predictable variations, or entropy, in the produced sound simulation output.

After all the action units and their interactions are constructed, and the iteration processes defined, one last thing needed for generation sound is energizing the system. That is because all units are initially in a steady or zero value state, and there is no interactions going on, just like there is no sound in a quiet environment where everything stands still. In natural world, sound is created when some event disrupt the steady state, like an object hitting another object, or air flows through a path. Similarly as provided by current invention, sounds are created by initially disturbing the states of some of the action units through timed events, or through feed in of random noise. Energizing is done by applying an input interaction to the system.

Finally, the output of sound is done by obtaining an output interaction from a plural of the action units, at each appropriate iteration step, and use the output interaction to calculate a normalized sample value. Such sample values are output sequentially to be used as raw audio data used by the conventional sampling based sound devices. Refer to claim 1 part 1G and 1H.

As explained, both input to the system, and output from the system is done through a plural of interactions, just the same as any two operating units can influence each other through an interaction. For this purpose, an input unit and a output unit can be constructed. The iteration steps of these two units are somewhat different from the other operating units. In each iteration step, the input unit translates the external input into values of its variables and derivatives. At the output unit, it translate values of its internal variables and derivatives into sampled signal output. Now let me use some embodiment examples to illustrate principles of current invention further.

### EMBODIMENT EXAMPLE ONE

Referring to claim 1, Embodiment Example One contains just one action units, one input unit and one output unit. The action unit contains a variable X, its time derivative V, and second time derivative A. The unit also contains constant parameters M, K and D, an action H(T) which equals to sum of interactions, and an action formula relating the variables together:

H(T)=M*A+D*V+K*K=H(T) (1)

Such a unit is analogy to a physical system of a mass M connected at the end of a spring with a spring constant K, and a damping coefficient D. The X stands for the displacement, V for velocity and A for acceleration. Action term H(T) represents interaction or excitement the unit receives at a given instance of time. When there is no external interaction, it is set to zero. To one familiar with physics, the above equation can be recognized as describing an oscillating spring, with spring constant K, and a mass M attached to one end, and a damping force equal to D times the velocity V, and an angular frequency W˜=SQRT(K*M−D²/4)/M.

To calculate the iteration process through a time step dT, we carry out the following calculations to update the variable values X, V and A. First, re-write the formula so that we can calculate instantaneous value of A, the acceleration:

A(T)=(H(T)−D*V−K*X)/M (2)

Once A is obtained, since it is the derivative of V, which is in turn the derivative of X, we can calculate updated value of V and X by accumulation, or integration:

V(T+dT)=V(T)+A(T)*dT (3)

X(T+dT)=X(T)+V(T)*dT (4)

Note that when the time interval dT is not infinitesimal, the above calculation is not mathematically precise, but contains a very small error. But the small error is OK. It actually helps because it introduces some entropy by introducing a variation and un-predictability.

An input unit is used to interact with the operating unit to energize it, by providing a push I(T). The input unit also contains variables x, its first derivative v and second derivative a. The interaction from the input unit, P(T), can be expressed as:

I(T)=m*a+d*v+k*x (5)

Unlike in a regular action unit, the variables of x, v and a in a input unit are fixed by the input directly. For example, the input may be a brief push by force. In such case, d and k are set to zero, m is set to 1, and a(T) is set to a non-zero value for a brief period of time. This is analogy to pushing a spring to displace it. The push results in non-zero acceleration A. After some iterations, it results in non-zero V and X. This is analogy to a spring begins to oscillate by itself. Finally, due to the damping term D*V, the variables decay over time towards zero. This is analogy to a spring losing energy over time.

Refer to claim 1 part 1G and 1H, the output of such a system can be obtained from an output interaction, which like the formula (5), can be expressed as a linear combination of the operating variable X, V and A. When such signal outputs are played, we can hear a decaying monotone sound on the speaker.

Of course, the above is an extremely simplified simulation system, with just one action unit, an input unit and an output unit. It is used for illustration of the basic principles.

Much more complicated systems capable of generating complicated sounds can be constructed, by using a lot of action units each defined by different parameters, and connects them into different topology structure, by applying different interactions. Initial excitements can be introduced towards different subset of action units. The final output can be obtained from different subsets of the action units. All these factors will affect the final outcome of sound generation, resulting in complicated, entropy rich natural sound with a natural warmth feeling.

### EMBODIMENT EXAMPLE TWO

Embodiment example two is similar to example one in that only one action unit, one input and one output is used. Refer to claim 2, instead of taking a short duration push as input, it takes the a series of sampled audio data as input. The system outputs a samples audio data, sampled at a different sample rate. Such a system converts audio data from one sample rate to another, for example converting audio recorded at 44.1 KHz to an audio at sample rate 8 KHz.

As provided by current invention, each action unit can be updated at different iteration time steps. In this embodiment example, the input unit will iterate at the sample rate of the input signal, i.e., 44100 times per second. The output unit will iterate at the sample rate of the output signal, i.e., 8000 times per second. The action unit will iterate at indefinite time intervals, i.e., iterate each time it interact with the input unit, which is 44100 times per second, or with the output unit, which is 8000 times per second. Refer to claim 3 on such a sample rate conversion.

At each iteration step, the input unit will convert the sampled input signal into values of its own variables, and then interact with the action unit. Assuming the input signal is Y, variables of the input units are calculated as such: The value Y is directly assigned to X; The difference of X from previous value is divided by the time step and assigned to V; Difference of V from previous value is divided by the time step and assigned to A. For easy calculation we set the time step to 1. For example, if values of the input Y are: . . . 1, 3, 7, then the input unit variable X will be 1, 3, 7, with 7 being its latest value. The value of V will be increment of X at each step, or 2, 4. The value A will be increment of V, or 2. In summary, X is just the input signal, V is derivative of X, and A is derivative of V.

The interaction of the input unit to the action unit is I(T), calculated as:

I(T)=m*A+d*V+k*X (5)

We choose suitable constants m, d, k to ensure that the frequency response of the interaction suppresses frequencies near or above half of the output sample rate of 8 KHz. Since we want a cut off frequency of 4 KHz, it is appropriate to choose a pair of (m, k) values that gives

W=SQRT(k/m)=2*PI*4000 Hz

As we set the time step of 44.1 KHz as 1, angular velocity W=2*PI*4 KHz/44.1 KHz=0.57. Thus it is appropriate to set k=1, d=W=0.57, and m=W*W=0.325 for the interaction. Through experimenting and theoretical calculation, a more suitable set of (m,d,k) values can be found to achieve the best result of sample rate conversion. Likewise, the action unit can have similar values of (M,D,K) defined. Finally, an output unit can be similarly defined as a linear combination of variables X, V, A in the action unit. The output interaction can be calculated 8000 times per second. The values obtained are normalized and output as sampled output data.

### EMBODIMENT EXAMPLE THREE

In embodiment example three, a plural of action units and interactions are used to construct a synthesis system. Specifically, a collection of 18 action units are used, including an input unit, an output unit and 16 action units. The 16 action units operates by the same method as described in the embodiment example one, but are assigned different values of M and K, giving them different frequency responses. Each of the action units interact with the input unit, taking input from the input unit and providing feedback to the same. The input unit carries its own set of M and K with allows proper frequency response. A linear combination of the X, V, A values of the main unit is used to calculate the audio sample outputs.

To energize such a system to generate sounds, a push is periodically provided to a randomly chosen subset of the sub units. The push is the I(T) term in formula (5). As the result of such periodical and random excitements, the system generate very rhythmic and harmonic rich sounds that sound like music drum beats. Each beat sounds very different from the next.

Such a system is still overly simplistic, as it allows only interaction between sub-units and a main unit. Much more complicated synthesis systems can be constructed using a bigger number of action units, and more complicated ways of inter-connecting the units using different interaction parameters. Finally complicated time events can be programmed to excite any combination of any of the units, in many possible ways. As a result, very complicated sounds with a lot of harmonies and warmth can be created, and they sound like natural sounds.

The action term H(t) actually constitutes two parts. One part is the interactions with the units, another part is energizing input E(t), similar to objects hitting or air flowing in the real physical world, both of which energize sounds generation. The interactions are mutual and opposite. If unit A gives unit B an interaction I(t), then the unit B receives an interaction -I(t) from unit A, i.e., the two mutual interactions are equal but opposite.

The unit interaction I₁(t) could be calculated based on the following general formula. It represents that action received by unit 1 equals action from unit 2 minus the action given to it:

I₁=I₁₂−I₂₁=(m*A₂+d*V₂+k*X₂)−(m*A₁+d*V₁+k*X₁) (6)

To summarize, it takes the following steps to assemble a digital sound simulation system based on the principles of the current invention;

Step One, define a set of variables for action units. The set of variables generally contains one or more variables, plus their first and second time derivatives. In embodiment examples explained within this document, only one variable is used, which is analogy to a displacement X. And only the first and second time derivative of the X, i.e., velocity V and acceleration A, are used. In more complicated systems according to current invention, more than one variables could be used. For example, we can use a set of three variables, the X, Y and Z coordinates, plus their first and second time derivative, totaling 9 variables for each action unit. For another example, we can extend to include the third, fourth or more time derivatives. All such variations in embodiment are meant to be included within the scope of current invention.

Step Two, define a set of parameters and a formula for actions and interactions. In embodiment examples discussed within this document, the action and interaction terms are both defined as simply a linear combination of the variable sets, based on chosen parameters:

H(T)=M*A+D*V+K*X and I(T)=m*A+d*V+k*X

More sophisticated formulas for action and interaction terms than a mere linear combination can be defined and used. But there are two conditions. The interactions must be mutual and opposite between two units; It must be possible to define a quantity energy using the variables, and the energy is guaranteed to be either conserved, or it can only slowly decaying towards zero. These two conditions ensures that any simulated sound can propagate and be sustained for at least a brief time period, so as to generate desired natural sound effects like echoes and reverberations.

Step Three, construct all the action units and their interactions by choosing proper parameters (M, D, K) and (m, d, k) for each one of them. Then choose proper time steps for the iterations of each action unit based on timing characteristics of the chosen parameters. Some of the units have slow time responses and can be iterated less often. Some other units may have fast time responses and must be iterated more often.

Step Four, for each iteration of each action unit, calculate its interactions and tally the interactions at the receiving units, and assign the total to the action value of each action unit. In another word, the action of each action unit equals to the total interactions it receives with an iteration time step. The action term is integrated over the time step before used to update a unit.

Step Five, to iterate an action unit, calculate the total action according to step four. Then use the action value calculated and the action formula to calculate and update the variables of the unit. First, the action formula can be transformed to allow the second derivative A to be calculated. Then, we can integrate the second derivative to obtain updated value of the first time derivative V. Finally, we integrate V to obtain the updated valued of displacement X.

Final Step. There can be multiple action units, with each represented by a set of variables and derivatives. But we must convert to and from the conventional digital audio data that contains only single sample values. We use input and output units for such conversion.

To convert from conventional audio sample to variables of the input unit, we can assign the sample value to variable X, and then assign the increment from last X to current X as valued of V. We similarly assign increment of V to the value of A. To convert from output unit to a single sampled value output, we can just calculate a linear combination of the unit variables. Both input and output units must iterate at the same sample rate as the input and output signal.

Several underlining principles ensures that such a system can generate natural sound. One, the characteristics of the action units and their interactions are so designed that the state of the system is not preserved, but the energy level is largely conserved, and only decays slightly over time. Two, the action units have their unique time-delayed response characters. Three, the system is designed to ensure that entropy of the system keeps increasing, and both energy and entropy is replenished by inputs which energizes the system to sustain the sounds generated. Through careful consideration of the energy, the timing and the entropy, current invention is novel, non-obvious, and is superior to the prior arts of digital sound creation and processing.

The energy conservation principle is essential in simulating natural sound. Because of it, sounds can be sustained, allowing them to be reflected and inter-mixed to generate rich echoes and reverberations. Moreover, when two action units of different frequency response interacts, one unit acquires energy and the other unit loses energy, thus energy is transferred from one frequency to another. When such energy transfer happens repeatedly, many harmonies in the sounds are generated. Prior arts try to sustain a sound by memorizing it. That is wrong.

The underline principles of current invention resembles classical dynamics expressed in quantities like the classical Lagrangian Mechanics, which should be familiar to anyone skilled in the prior art of related fields. Such similarity ensures energy conservation principle is obeyed. From microscopic or quantum mechanics point of view, energy is absolutely conserved. There is nothing in the microscopic world that can make energy disappear or dissipate. Energy is simply transferred from one form to another, but never disappeared. Sound waves can travel hundreds of meters and carried by gazillions of air molecules with very small loss of energy. Any energy loss in sound waves is transfer to higher pitch sounds we cannot hear, and eventually turned into heat.

### Novelty, Non-Obviousness and Useful Value of Current Invention

Claims of current invention are novel as no prior arts are known to do things similar to that provided by current invention. For decades, researchers and engineers relied on the DSP (Discrete Signal Processing) theories and algorithm to implement signal processing for digital sound applications. DSP circuit chips and software codes are widely used as the standard tools. There are no known prior arts which attempt to deviate from the DSP principles and processes digital signals in a radically different paradigm as provided by current invention, a scheme that is related to the century old and long forgotten classical Lagrangian Mechanics in a digital age.

The current invention is also non-obvious. In the field of digital signal processing, signals are routinely amplified and their frequency spectrum modified by digital filters. When a signal is amplified, there is no need for energy conservation. Likewise, entropy is considered a noise to the signal. So lots of efforts were spend to reduce noise and reduce entropy, to obtain high fidelity signal processing result. It does not appear obvious to those skilled in the field of the arts that a better scheme for digital sound generation and processing must be forgetful of previous states, obeys energy conservation, and allow entropy to increase. By following these critical physics laws, current invention provides novel principles that allow creation of highly realistic sounds, and realistic sound effects by computing processes.

The methods and apparatuses provided by the current invention are very useful and extremely valuable to the fields of multimedia content production and distribution, including the music and movie industry, gaming industry, and mobile communication and social networking industry. A long time holy grail of the digital signal processing technology sector is the ability to realistically simulate natural sound effects in the physical world. Such a holy grail was difficult to achieve due to the limitation of the conventional DSP technology. Current invention makes such a goal possible and within reach, with the computing power already available today.

Practical embodiments may vary. All such variations that do not deviated from the underline invention principles of a forgetful system that obeys energy conservation and allows entropy increase, are intended to be included within the scope of the current invention claims.

### INDUSTRY APPLICABILITY

The current invention is novel, useful and non-obvious and can be utilized in the industrial application of digital sound generation and processing, including audio and music and movie content creation and processing, virtual reality games, text to speech conversion, and or any other application that produces sounds for human user to hear, including human machine interaction and virtual environment simulation.

The current inventor claims:

1. A method to generate and process digital signal by computation, comprising of the following components and processing steps:
1A. Allowing sequential inputs from a series of timed trigger events or digital signals;
1B. Providing actions and interactions as defined by a plural of formulas containing a plural of parameters, variables and their time derivatives, such formulas ensure the existence of a conserved or slowly decaying quantity, analogy to physical energy;
1C. Providing a plural of action units each contains variables and actions as said in 1B, and that interact with each other through interactions as said in 1B, and said interactions are mutually equal and opposite between any two said action units;
1D. Containing a plural of interactions between the above said action units, with each interaction specified by a formula as said in 1B, and such interactions connect said action units to form grids of specific topology shape and form, thus allowing digital signals of specific characters to be generated by such topology structure;
1E. Containing an input unit or other provisions to convert an input digital signal or other inputs to the said interaction so as to affect and modify the status of the said action units;
1F. Containing a plural of iteration methods to update and modify each action unit over time, based on the actions and interactions received during each iteration time period;
1G. Containing an output unit of other provisions to calculate a sequential output signal;
1H. Allowing such outputs to be recorded for later usage and/or turned into analog signal.

2. A method according to claim 1, wherein the said input signal in step 1A and the output signal in step 1G and 1H are sampled digital sounds that can be rendered into physical sounds.

3. A method according to claim 1, wherein the input is samples digital sound signal, and the output is also sampled digital sound signal. and the processing steps as described in claim 1 result in an output sound signal of modified characteristics compared with the input sound signal.

4. A method according to claim 1, wherein the constants used in each action unit and in each interactions can be varied over time, and action units can be added or removed, and interactions can be changed over time, thus such changes result in variations of the output signal.

5. A method according to claim 1, wherein the input signal is a sequence of timed events that energize the action units through interactions, and the output is a digital sound signal.

6. A method according to claim 1, wherein the input signal is a digital audio signal, the output is a digital audio signal that is similar to the input but modified to create audio effects, and wherein information of the state of action units are collected and compressed for storage and for transfer so as when the information is restored for processing, the original audio is replicated.

7. A method according to claim 1, wherein multiple input signals from multiple sources at different locations are provided, and multiple output signals are generated, and wherein such multiple output signals are rendered into physical sound at different locations or near different ears of a human user, creating a perception of hypothetical locations of different sound sources.

8. A method according to claim 1, wherein multiple input signals recorded or artificially generated are provided, and the system of action units and their interactions are so configured as to generate one or multiple output audio signals that give perception of the sound effects from a simulated physical environment, like echoes and reverberations.

9. An apparatus according to claim 1, wherein said apparatus is energized by a sequence of timed events or by input sound, and outputs digital audio signal that can be turned into sound.

10. An apparatus according to claim 2, wherein that said apparatus may take signal input and generate signal output in computer data form, or said apparatus may contain components to record physical sound, and or components to generate physical sound wave from output signal.

11. An apparatus according to claim 3, wherein the input may be computer audio data, or recorded audio samples, and the processed outputs are audio sample data of modified characters, like a different sample rates or modified frequency spectrum in the audio.

12. An apparatus according to claim 4, wherein the characteristics of the action units and interactions are changed over time by modifying the constants contained, resulting in a modified output, similar to the changing physics characteristics of objects affect the sounds they generate.

13. An apparatus according to claim 5, wherein said apparatus accept sequences of timed events as inputs which energizes the action units so as to produce simulated digital sound output.

14. An apparatus according to claim 6, wherein said apparatus accept a pre-recorded or real time recorded audio signal as input, and generates compressed data from the action units that can be delivered to a remote location and used to replicated said audio signal with audio effects.

15. An apparatus according to claim 7, wherein said apparatus accept a pre-recorded or real time recorded audio signal as input, and generates multiple audio outputs that when rendered into physical sound using proper devices at proper locations, can generate auditory perceptions of hypothetical locations of multiple sound sources, thus producing desired spatial sound effects.

16. An apparatus according to claim 8, wherein said apparatus accept either recorded or generated audio signal as input, and generates multiple audio outputs that when rendered into physical sound properly, gives auditory perceptions of sound locations and environmental effects on the sounds, like echoes and reverberations, so as to simulate the perception of being in a real physical environment that is otherwise impossible or inconvenient for a human user to be present.
